(19) United States
(12) Patent Application Publication
(10) Pub. No.: US 2012/0299376 A1
(43) Pub. Date: Nov. 29, 2012

(54) WIND POWER PLANT COMPRISING A BATTERY DEVICE

(75) Inventors: Tim Schaefer, Harztor (DE); Andreas Gutsch, Luedinghausen (DE)

(73) Assignee: LI-TEC BATTERY GMBH, Kamenz (DE)

(21) Appl. No.: 13/504,937

(22) PCT Filed: Oct. 20, 2010
(86) PCT No.: PCT/EP2010/006426

§ 371 Date: Aug. 17, 2012

(30) Foreign Application Priority Data
Oct. 29, 2009 (DE) 10 2009 051 215.2

(51) Int. Cl. H02J 7/00; B60L 1/00

(52) U.S. Cl. 307/9.1; 320/101

(57) ABSTRACT

A wind power plant, in particular for use on or in a water system, includes a wind wheel, a generator, which can be brought into driving engagement with the wind wheel, and a battery device including at least one electrochemical cell.

### CROSS-REFERENCE TO RELATED APPLICATIONS

This application is a national stage application under 35 U.S.C. §371 of International Application No. PCT/EP2010/006426, filed Oct. 20, 2010 and published as WO 2011/050923, which claims priority to German patent application number DE 10 2009 051 215.2, filed Oct. 29, 2009, the entirety of each of which is hereby incorporated herein by reference.

### SUMMARY

The present invention relates to a wind power plant, and more particularly to a wind power plant for use on or in a water system.

Wind power plants of this type are used in what are known as offshore plants located in the open sea. In general, there is no direct access to land. In particular when using such wind power plants in the ocean, the environmental factors, notably caused by the salt water, pose great challenges for the design of such wind power plants. Moreover, the transportation of electrical energy that is generated to the consumers requires special attention.

Such wind power plants, however, can also be used in the vicinity of or on inland water systems, and more particularly large lakes, because high winds can occur there as well.

Regenerative energies, such as wind energy or solar energy, for example, have the disadvantage of fluctuating power output. With the corresponding atmospheric conditions, wind power plants or solar power plants can output high power, while the power output can drop to a very low value within a short time with a corresponding change in the atmospheric conditions. Such fluctuations necessitate the storage of electrical energy that is generated under favorable atmospheric conditions. When the wind power plants or the solar plants deliver little power, the stored energy can compensate for the reduced power output.

DE 202 06 234 U1 shows a buoyant wind power plant. It comprises a float which floats on the water surface. The buoyant wind power plant can be anchored in the region close to the coast. A buffer battery for emergency power can be accommodated in the region of floats.

DE 197 14 512 C2 shows a maritime power plant system together with a production process for generating, storing and consuming regenerative energy. A floating carrier structure is provided, on which several wind energy converters are arranged.

DE 20 2009 006 647 U1 shows a power tower to which a rechargeable battery bank for storing power is connected. Electrical vehicles, for example, can be recharged at this power tower.

It is an object of the present invention to provide an improved wind power plant.

The object underlying the present invention is achieved by a wind power plant, in particular for use on or in a water system, comprising a wind wheel, a generator which can be brought into driving engagement with the wind wheel, and a battery device comprising at least one electrochemical cell.

A wind power plant within the context of the present invention shall be understood to mean a system that can convert kinetic energy of the wind into electrical energy. Electrical energy within the context of the present invention shall also include electrical energy that is stored in chemical form. The kinetic energy is converted into kinetic energy of the wind wheel, in particular by utilizing the Bernoulli effect. When the wind wheel is in driving engagement with the generator, the rotation of the wind wheel drives the generator and can generate electrical energy.

Within the context of the present invention, a battery device shall be understood to mean a device which comprises at least one electrochemical cell. The battery device may comprise structural means, in particular a housing, which are able to support the electrochemical cell in a position-stable manner. The battery device can comprise means for contacting the electrochemical cell. The housing can seal the electrochemical cell with respect to the surroundings.

Within the context of the present invention, an electrochemical cell shall be understood to mean a device which can also be used to store chemical energy and to deliver electrical energy. For this purpose, the electrochemical cell can comprise at least one electrode stack, which shall also be considered to include electrode windings, which is delimited in a substantially gas- and liquid-tight manner with respect to the surroundings by means of a casing. The electrochemical cell can also be designed to take up electrical energy during charging. It is then referred to as a secondary cell or a storage battery.

The battery device is preferably designed such that it can take up significant portions of the electrical energy generated by the generator at least intermittently. This means that the battery device can receive at least 50%, in particular at least 75%, in particular 90%, and in particular 100% of the maximum electrical energy that the generator can generate and convert it into chemical energy. In this respect, the battery device preferably provides considerably higher capacities for converting electrical energy into chemical energy than batteries or buffer batteries acting as emergency power units are able to supply, for example. With a battery device of this type, it is possible to achieve the storage of electrical energy during times in which the wind power plant can produce a lot of electrical energy. Moreover, during times in which the generator generates little electrical energy due to low winds, the battery array can provide electrical energy.

The water of the water system can preferably flow directly around a housing of the battery array and/or a casing of an electrochemical cell. The water of the water system preferably is understood to mean the seawater or the water of a lake or river in or on which the wind power plant is installed. The water of the water system can be used to control the temperature of the battery array and/or of the electrochemical cell. The North Sea, for example, has water temperatures of approximately 10° C. during winter and of approximately 25° C. during summer. The resulting temperature difference of approximately 15° C. over the course of the year represents a very low temperature fluctuation as compared to the fluctuations which can occur during the operation of electrochemical cells. Seawater is thus excellently suited to control the temperature of electrochemical cells under substantially consistent outside conditions. Because the housing of the battery device and/or the casing of an electrochemical cell can come in direct contact with the water, the design for cooling can be kept simple. The battery device can be arranged at least partially, and more particularly completely, below a water surface of the water system. The battery device and/or the electrochemical cell are preferably in contact at least with parts of the water during all tidal conditions.

As an alternative or in combination therewith, means for delivering water from the water system to the battery device can be provided. Independence from the water level of the water system, and notably from the tidal range, can thus be achieved. The delivery means can comprise a pump.

As an alternative thereto or in combination therewith, a separate heat cycle can be provided which is in thermal contact both with at least one electrochemical cell and with the water of the water system. The thermal contact can be formed directly with the electrochemical cell or indirectly via parts of the battery device. In such an arrangement, the battery device and/or the electrochemical cell are preferably spatially separated from the water of the water system. This is notably of advantage when the water of the water system contains salt, because salty water can chemically corrode the casing of the electrochemical cell and/or the housing of the battery device. Moreover, the battery device can be installed in locations which the water of the water system cannot reach on its own.

A battery device is preferably detachably fastened in a housing of the wind power plant. A detachable connection shall be understood to mean such a connection which is designed to be released and restored several times within the scope of the proper operation of the wind power plant. Replacing the battery device forms part of the routine use of the wind power plant. Removal of the battery device merely for maintenance purposes does not constitute a routine use of the wind power plant. A detachable connection is notably suitable for automatically detaching and fastening the battery device in the housing of the wind power plant. It can thus be achieved in particular that portions of the electrical energy generated by the wind power plant are transported away from the wind power plant with the battery device. The detachable connection can be implemented by means of an insertion device. The battery device can be secured by suitable retaining means, for example pins, to prevent inadvertent release. A battery device that is detachably arranged in this way is preferably arranged on an outside of the housing of the wind power plant so as to allow simplified installation and removal.

The battery device is preferably arranged outside of a wind power plant housing. A wind power plant housing shall be understood to mean such a device which is arranged in a substantially stationary manner on parts of the wind power plant and can protect at least parts of the wind power plant from environmental factors. Moreover, the wind power plant housing can accommodate support functions for components of the wind power plant. Because the battery device is arranged outside of the wind power plant housing, the battery device can be easily removed from the wind power plant. This is particularly of advantage when a battery device that can be detached from the wind power plant housing is used, which can be designed in particular to be frequently removed from the wind power plant and reinstalled.

The wind power plant preferably comprises exclusively battery devices as devices for delivering electrical energy. These are fastened in particular detachably to the wind power plant. If only battery arrays are provided for the delivery of electrical energy, wire connections to the wind power plant are not necessary. The electrical energy is thus transported away from the wind power plant together with the battery devices. The battery devices can be lifted directly onto a ship by means of a crane. The battery devices can also be used to provide the ship with driving power or supply energy. A wind wheel comprising a removable battery device in this respect represents a kind of charging station for electrically operated ships. This is advantageous in particular with wind power plants that are installed at large distances from the mainland.

As an alternative to or in combination with the aforementioned options, the battery device can be arranged in a foundation of the wind power plant. The mass of the battery devices can notably be used as foundation mass for fixing the wind power plant. Notably maintenance-free lithium-ion batteries are suitable for this purpose. Moreover, almost any location on a housing of the wind wheel can be filled with electrochemical cells.

The present invention further relates to a method for providing a ship with driving power and/or supply energy, wherein a battery device is removed from an aforementioned wind power plant and subsequently inserted in a ship. Driving power shall be understood to mean the energy which is used for the propulsion of the ship. The driving power is usually converted by means of a motor via propellers or screws. Supply energy shall be understood to mean the energy which is not required for the propulsion of the ship and instead is used to supply power to other technical installations of the ship, such as control units or air conditioning units, for example. The supply energy on ships or airplanes is generally provided by an auxiliary power unit (APU). The battery device, which now provides the supply energy of a ship, can replace such an APU.

The present invention further relates to a method for controlling the temperature of an electrochemical cell, wherein an exchange of energy from the electrochemical cell with at least parts of the surroundings is carried out by way of a heat exchange device, characterized in that a heat exchange with the water of a water system takes place, and more particularly with the water of an ocean or an inland water system. A heat exchanging device can be understood to mean a heat exchanger. A heat exchanging device, however, can also merely be provided by a housing. To this end, an outer surface of the housing can come in contact with the water of the water system. An inside surface of the housing can take up energy from the electrochemical cell.

The water of the water system preferably has direct contact with a housing which accommodates the electrochemical cell, or with a casing of the electrochemical cell. A heat exchanging device having a simple design can thus be provided. Uniform temperature control can be assured by the substantially consistent temperatures of the water of a water system.

As an alternative, the electrochemical cell can be in heat-transferring contact with a cooling liquid circuit, wherein the cooling liquid circuit is in heat-transferring contact with the water of a water system.

Further advantages, characteristics, and application options of the present invention will be apparent from the following description in connection with the figures. In the drawings.

### BRIEF DESCRIPTION OF THE DRAWINGS

FIG. 1 shows a wind power plant in a first embodiment.

FIG. 2 shows a wind power plant in a second embodiment.

FIG. 3 shows a wind power plant in a third embodiment.

FIG. 4 shows a wind power plant in a fourth embodiment.

FIG. 5 shows a wind power plant in a fifth embodiment.

FIG. 6 shows a wind power plant in a sixth embodiment.

FIG. 7 is a detail of a wind power plant housing comprising an inserted battery device.

FIG. 8 is a schematic illustration of a cooling cycle a) in a first embodiment, and b) in a second embodiment.

FIG. 9 is a battery device which is arranged outside of a wind power plant housing.

### DETAILED DESCRIPTION

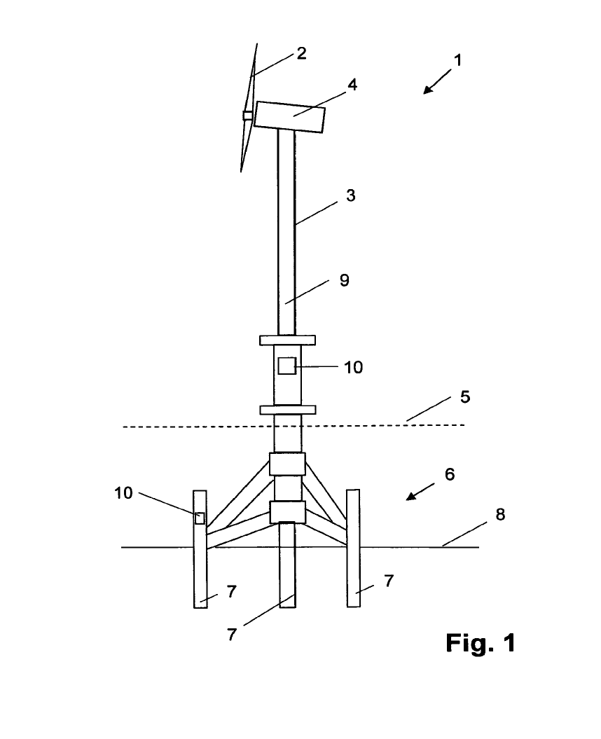

FIG. 1 shows a wind power plant 1 for use in the open sea in a first embodiment. The wind power plant 1 comprises a wind wheel 2, which is arranged on a wind power plant housing 3. A generator 4, which is drivingly connected to the wind wheel 2, is provided in an upper part of the wind power plant housing 3. A foundation 6, which holds the entire wind power plant 1 in position, is provided beneath the water surface 5. The foundation 6 has the shape of a tripod formed by three steel piles 7. The steel piles 7 are driven into the ocean bed 8. A central pylon 9 connects the foundation 6 to the upper part of the wind power plant housing 3. A housing which accommodates the generator 4, the pylon 9 and the foundation 6 form integral parts of the wind power plant housing 3.

A respective battery device 10 is arranged inside one or more steel piles 7. A further device array 10 is arranged inside the pylon 9. The battery devices 10 are arranged inside the wind power plant housing 3. Instead of the battery devices 10, it is also possible to use individual electrochemical cells, which also applies to the following embodiments.

The space provided by the steel piles 7 and the pylon 9 is thus used efficiently by the battery devices 10. And in addition, the weight of the battery devices 10 can be used to stabilize the foundations.

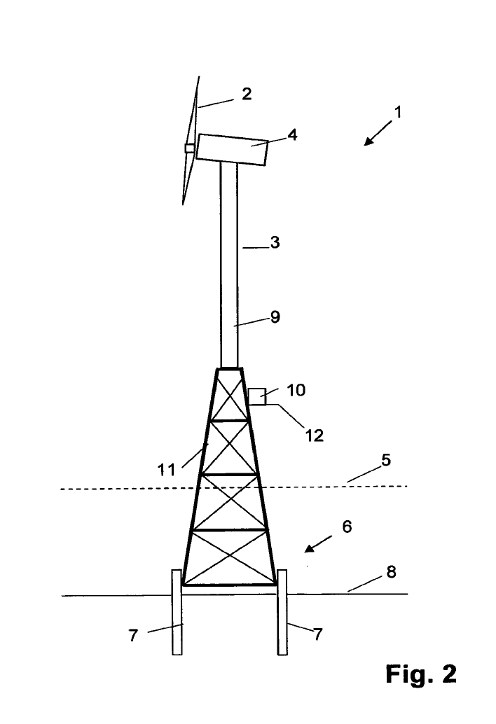

FIG. 2 shows a wind power plant 1 in a second embodiment, which corresponds substantially to the first embodiment. Hereafter, only the differences will be addressed. The foundation 6 of the wind power plant 1 has a lattice-like structure made of steel elements 11, on the bottoms of which four steel piles 7 are provided, which are arranged squarely with respect to each other. A supporting device in the form of a plateau, on which a battery device 10 can be arranged, is designed on the lattice-like structure made of steel elements 11. The battery device 10 is arranged outside of the wind power plant housing 3 in this case.

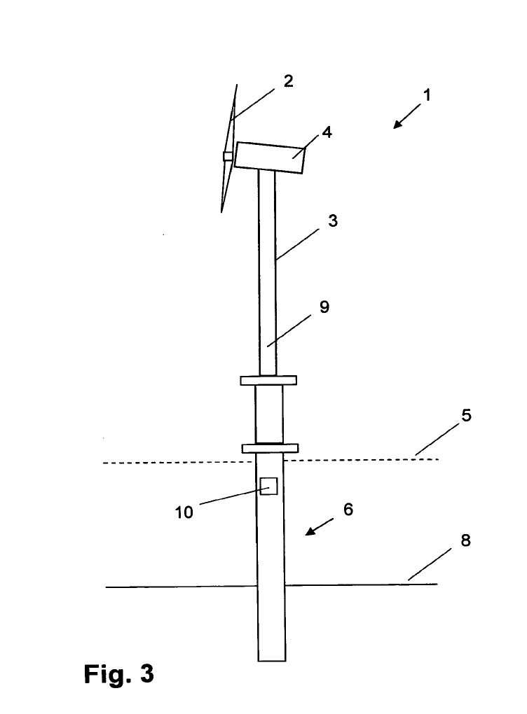

FIG. 3 shows a wind power plant 1 in a third embodiment, which corresponds substantially to the first embodiment. Hereafter, only the differences will be addressed. The wind power plant housing 3 essentially comprises a pylon 9, which also forms the foundation 6. Over its length, the pylon 9 has differing diameters and it is driven into the ocean bed 8. A battery device 10 is arranged in the lower part of the pylon 9 beneath the ocean surface.

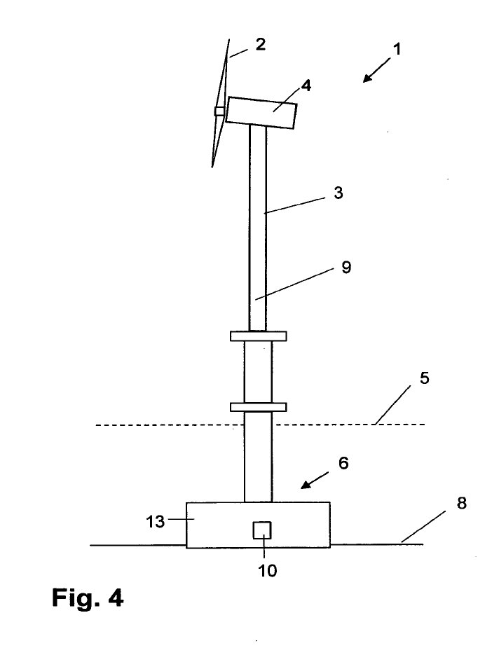

FIG. 4 shows a wind power plant 1 in a fourth embodiment, which corresponds substantially to the third embodiment. Hereafter, only the differences will be addressed. A gravity body 13, which bears against the ocean bed 8, is provided at a lower end of the pylon 9. A decisive portion of the weight of the gravity body 13 is formed by battery devices 10 located on the inside.

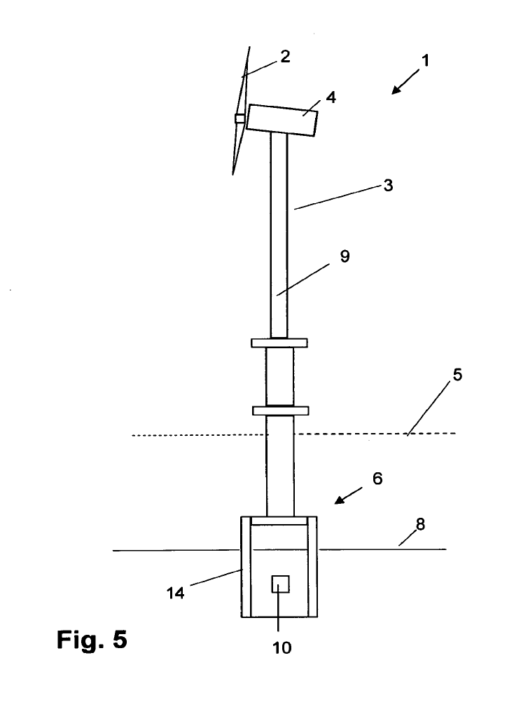

FIG. 5 shows a wind power plant 1 in a fifth embodiment, which corresponds substantially to the fourth embodiment. Hereafter, only the differences will be addressed. The foundation 6 is formed essentially by a bucket 14 in which ballast is arranged. Some of the ballast is formed by battery devices 10. The pylon 9 is rigidly connected to the bucket 14.

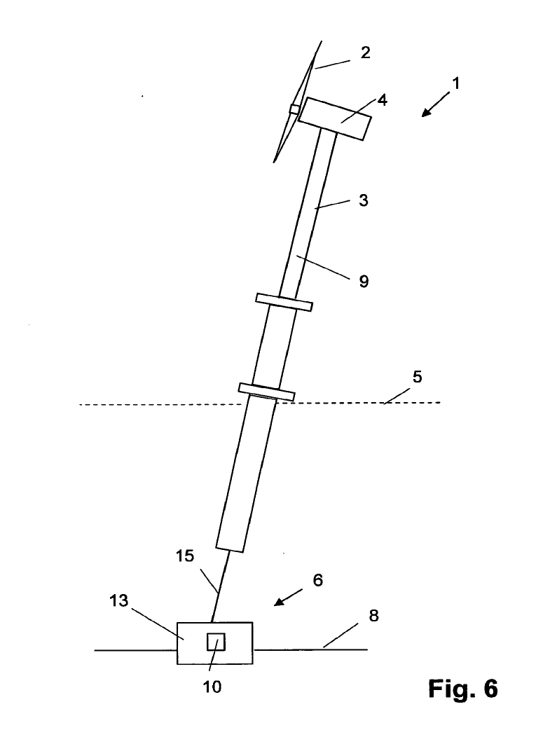

FIG. 6 shows a wind power plant 1 in a sixth embodiment, which corresponds substantially to the fourth embodiment. Hereafter, only the differences will be addressed. The pylon 9 essentially has a floating design. A cable 15 connects the pylon 9 to the gravity foundation 13 in which battery devices 10 are arranged.

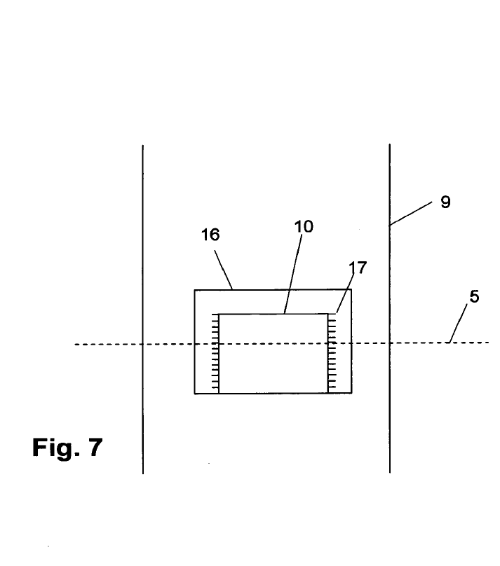

FIG. 7 shows, by way of example, the arrangement of the battery device 10 inside the pylon 9. A recess 16 is provided, which is located approximately in the region of the water surface 5. The battery device 10 is held inside the recess 16 and is in direct contact with the water. Cooling fins 17 are provided on the housing of the battery device 10 so as to allow better heat dissipation from the battery housing to the water. The cooling fins 17 are used to break the waves. The battery device 10 is held detachably inside the pylon.

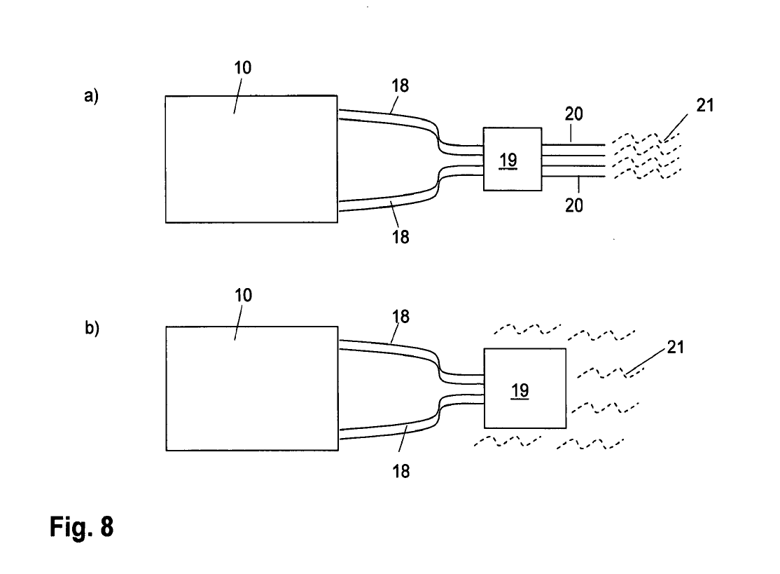

FIG. 8a is a schematic illustration of the design of the heat exchanging device. The battery device 10 is connected to a separate heat exchanger 19 via lines 18. Additional lines 20 are arranged on the heat exchanger 19 and intended to deliver ocean water 21 to the heat exchanger 19. Deviating from this, the heat exchanger 19 is arranged directly in the ocean water 21 in the design according to FIG. 8b. The additional lines 20 can thus be eliminated.

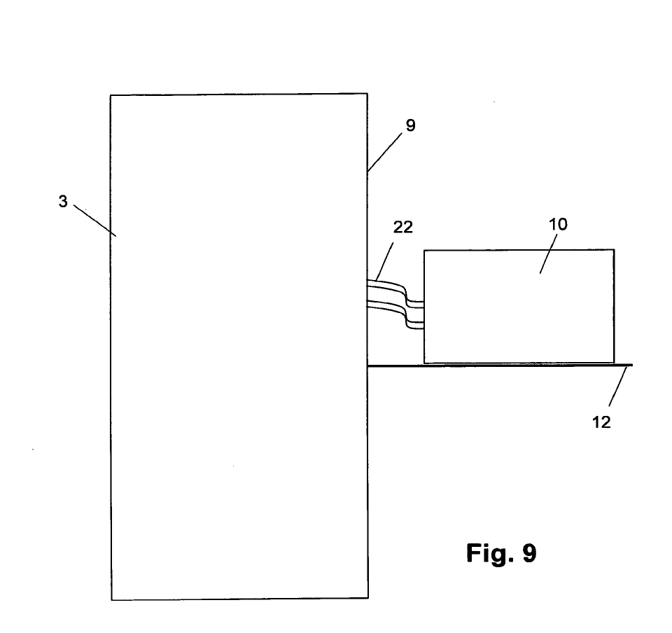

FIG. 9 shows a schematic illustration of the arrangement of the battery device 10 on the plateau 12. The plateau 12 is arranged outside of the wind power plant housing 3. The battery device 10 can be protected against environmental factors by another housing, which is not shown. This additional housing can be removed or allows easy access to the battery device 10 in another manner. The additional housing is not an integral part of the wind power plant housing 3. The battery device 10 is connected via lines 22 to the generator 4, which is not shown. By arranging the plateau 12 outside of the wind power plant housing, a crane, which is not shown, can transport the battery device 10 away from the wind power plant, for example to a ship.

### LIST OF REFERENCE NUMERALS

1 Wind power plant
2 Wind wheel
3 Wind power plant housing
4 Generator
5 Water surface
6 Foundation
7 Steel pile
8 Ocean bed
9 Pylon
10 Battery device
11 Lattice-like structure made of steel elements
12 Supporting device
13 Gravity body
14 Bucket
15 Cable
16 Recess
17 Cooling fin
18 Lines
19 Heat exchanger
20 Lines
21 Sea water
22 Lines

1-13. (canceled)

14. An off-shore wind power plant, comprising:
a wind wheel;
a generator configured be brought into driving engagement with the wind wheel; and
a battery device comprising at least one electrochemical cell to take up significant portions of the electrical energy generated by the generator,
wherein the at least one electrochemical cell is in heat exchange with a water of a water system in or on which the wind power plant is installed.

15. The wind power plant according to claim 14, wherein the water of the water system flows directly around a housing of the battery device and/or a casing of an electrochemical cell.

16. The wind power plant according to claim 14, wherein the wind power plant comprises means for delivering water from the water system to the battery device.

17. The wind power plant according to claim 14, wherein
the battery device and/or an electrochemical cell are arranged at least partially, and more particularly entirely, below a water surface of the water system.

18. The wind power plant according to claim 14, wherein a heat cycle is provided, which is in thermal contact both with at least one electrochemical cell and with the water of the water system.

19. The wind power plant according to claim 14, wherein the battery device is detachably fastened in the wind power plant.

20. The wind power plant according to claim 14, wherein the battery device is arranged outside of a wind power plant housing.

21. The wind power plant according to claim 14, wherein only battery devices are provided as a device for delivering electrical energy.

22. The wind power plant according to claim 14, wherein the battery device is arranged in a foundation of the wind power plant.

23. A method, comprising:
providing a ship with driving power and/or supply energy using an offshore wind power plant according to claim 14, wherein a battery device is removed from the wind power plant and subsequently inserted in the ship.

24. A method, comprising:
operating an offshore wind power plant comprising a wind wheel, a generator configured to be brought into driving engagement with the wind wheel, and a battery device comprising at least one electrochemical cell to take up significant portions of the electrical energy generated by the generator, in which an exchange of thermal energy from the electrochemical cell with at least parts of the surroundings is carried out by way of a heat exchange device, wherein a heat exchange with water of a water system takes place, and more particularly with the water of an ocean or an inland water system in or on which the wind power plant is installed.

25. The method according to claim 24, wherein the water of the water system has direct contact with a housing accommodating the electrochemical cell or with a casing of the electrochemical cell.

26. The method according to claim 24, wherein the electrochemical cell is in heat-transferring contact with a cooling liquid circuit, wherein the cooling liquid circuit is in heat-transferring contact with the water of a water system.
